(19) United States
(12) Patent Application Publication
(10) Pub. No.: US 2026/0194985 A1
(43) Pub. Date: Jul. 9, 2026

(54) System and method for gesture detection

(71) Applicant: Doublepoint Technologies Oy, Helsinki (FI)

(72) Inventors: Arttu Tolvanen, Helsinki (FI); Ohto Pentikäinen, Helsinki (FI)

(21) Appl. No.: 19/438,717

(22) Filed: Jan. 2, 2026

Related U.S. Application Data
(60) Provisional application No. 63/741,932, filed on Jan. 5, 2025.

(51) Int. Cl. G06F 3/01

(52) U.S. Cl. CPC G06F 3/017; G06F 3/014

(57) ABSTRACT

According to an example aspect of the present invention, there is provided a system for gesture recognition comprising a first wearable sensor apparatus, a second sensor apparatus and a controller configured to compute at least one motion feature, the computing based at least in part on the received data from the first wearable sensor apparatus and the received data from the second sensor apparatus, provide the computed at least one motion feature to a gesture classifier, determine, using the gesture classifier, the user gesture based at least in part on the computed at least one motion feature, and output the determined user gesture.

### FIELD

This disclosure provides a system and method for detecting and measuring gestures, in particular in the field of wearable applications, for example extended reality applications or communications applications. More specifically, the present disclosure provides a gesture classifier which classifies gestures based on user movement information.

### BACKGROUND

Users may perform various gestures, but recognizing them automatically may be challenging. Camera-based systems necessarily rely on unobstructed views of the user, which might not always be readily available.

### SUMMARY OF THE INVENTION

The invention is defined by the features of the independent claims. Some specific embodiments are defined in the dependent claims.

According to a first aspect of the present invention, there is provided a system comprising: a first wearable sensor apparatus comprising a IMU configured to measure a user, a wearable component, for example a mounting component, attached to the IMU; the system further comprising a second sensor apparatus comprising a sensor element comprising at least one of: a IMU or a UWB antenna, configured to measure a user, and the system further comprising a controller comprising a processing core, at least one memory including computer program code; the first wearable sensor apparatus and the second sensor apparatus being configured to communicate with the controller, the at least one memory and the computer program code being configured to, with the at least one processing core, cause the controller at least to: receive data from the first wearable sensor apparatus, the data comprising measured IMU data related to a user gesture, receive data from the second sensor apparatus, the data comprising at least one of: IMU data, UWB data, or barometer data, compute at least one motion feature, the computing based at least in part on the received data from the first wearable sensor apparatus and the received data from the second sensor apparatus, provide the computed at least one motion feature to a gesture classifier, determine, using the gesture classifier, the user gesture based at least in part on the computed at least one motion feature, and output the determined user gesture.

According to a second aspect of the present invention, there is provided a method for gesture identification, the method comprising: receiving data from the first wearable sensor apparatus, the data comprising measured IMU data related to a user gesture, the user gesture comprising at least one motion feature, receiving data from a second sensor apparatus, the data comprising at least one of IMU data, UWB data, barometer data, the first wearable sensor apparatus and the second sensor apparatus being configured to communicate with a controller comprising a processing core, at least one memory including computer program code, computing, by the controller, at least one motion feature, the computing based at least in part on the received data from the first wearable sensor apparatus and the received data from the second sensor apparatus, providing the computed at least one motion feature to a gesture classifier, determining, using the gesture classifier, the user gesture based at least in part on the computed at least one motion feature, and outputting the determined user gesture.

According to a third aspect of the present invention, there is provided a non-transitory computer readable medium having stored thereon a set of computer readable instructions that, when executed by at least one processor, cause an apparatus to at least perform the first aspect or the second aspect.

Various embodiments of the second or third aspect may comprise at least one feature from the following bulleted list:
wherein the computed motion features comprise axis-specific motion features, for example acceleration and velocity along the palmar/dorsal, ulnar/radial, and up/down axes,
wherein the computed motion features comprise axis of rotation estimation, for example analyzing rotational velocity based on gyroscope data to determine angular motion, and correlating rotational velocity with acceleration vectors,
wherein the computed motion features comprise temporal and/or frequency domain features, for example time-domain metrics comprising at least one of peak acceleration, velocity magnitude, and duration of motion events; and/or frequency-domain analysis comprising identification of periodic and/or oscillatory motion patterns, wherein the patterns may be associated with specific predetermined gestures,
wherein the first wearable sensor apparatus and/or the second sensor apparatus is configured to be connected to the controller using a wired connection,
wherein the first wearable sensor apparatus and/or the second sensor apparatus is configured to be connected to the controller using a skin surface electrical connection.

### BRIEF DESCRIPTION OF THE DRAWINGS

FIGS. 1A, 1B and 1C 3C illustrate schematic views of exemplary systems in accordance with at least some embodiments of the present disclosure;

FIGS. 2A and 2B illustrate the biology of a user in accordance with at least some embodiments of the present disclosure,

FIGS. 3A and 3B illustrate schematic views of exemplary systems in accordance with at least some embodiments of the present disclosure,

FIG. 4 illustrates exemplary sensor data measured during a gesture in accordance with the present disclosure, and

FIG. 5 illustrates in flowchart form an exemplary process in accordance with the present disclosure,

FIG. 6 illustrates in flowchart form an exemplary process in accordance with the present disclosure,

FIG. 7 illustrates in flowchart form an exemplary process in accordance with the present disclosure,

FIG. 8 illustrates a schematic view of an exemplary system in accordance with at least some embodiments of the present disclosure, and

FIG. 9 illustrates a schematic view of an example system in accordance with at least some embodiments of the present disclosure.

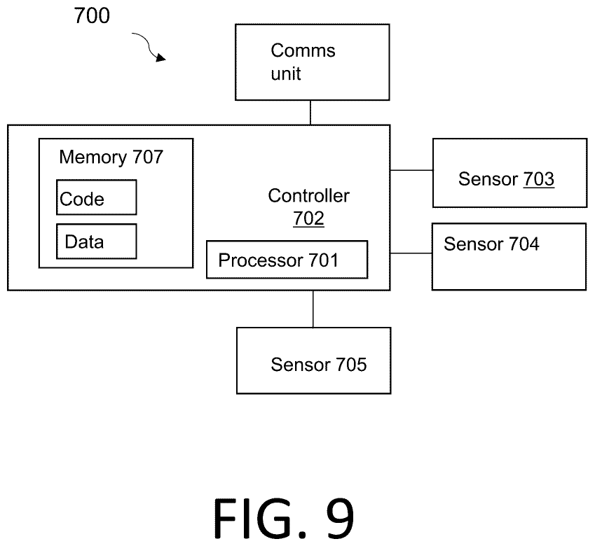

### EMBODIMENTS

Systems and methods are provided herein which allow for gesture recognition based on motion feature computation and gesture classification of measured gestures. A reference point, provided by a second sensor apparatus, for example, may be used to improve the accuracy of the recognition.

### Definitions

Activity refers to change in motion, position, and/or movement of a body part of a user, such as an extremity, for example, an arm and/or wrist.

Gesture refers to an action, such as an action depicting an intent for a further action. For example, a gesture refers to a movement or a combination of sequential and/or concurrent movements of an extremity or part thereof, having thereon a prescribed meaning in the context of said movement. For example, wave of the hand may be a gesture.

Arm refers to the upper limb of a user's body, comprising a hand, a forearm and an upper arm. Wrist refers to a body part which connects the forearm and the hand.

A wearable device refers to an apparatus configured to be worn by a user.

A mounting component refers to component which is configured to be worn by a user and also attach to or provide a housing for further components. An apparatus comprising a mounting component is thus a wearable apparatus. A mounting component may be any of the following: a hook-and-loop fastener, a carabiner, a strap, a band, a torc, a ring, a wristband, a bracelet, a glove, glasses, goggles, a helmet, a cap, a hat, a head band, or similar head gear. A hand wearable device refers to a wearable device that is configured to be mounted and/or attached to an arm, hand, palm, back of a hand, wrist or finger of a user.

Wrist-wearable mounting components may be any of the following: a strap, a band, a wristband, a bracelet, a torc. Finger-wearable mounting components may be any of the following: a ring, a finger sleeve, a thimble. The mounting component may be attached to and/or formed by another apparatus such as a smartwatch, or form part of a larger apparatus such as a gauntlet, or a headset. In some embodiments, a strap, a band, and/or a wristband has a width of 2 to 5 cm, preferably 3 to 4 cm, more preferably 3 cm. The mounting component may be attached to and/or formed by another apparatus such as a XR controller.

The term first wearable sensor apparatus refers to a wearable device. For example, the user may wear the first wearable apparatus on an extremity of the user, for example, foot, leg, head, arm, hand, palm, back of a hand, wrist or finger of the user. The first wearable sensor apparatus may comprise a mounting component, such as a strap, a band or a ring. For example, the first wearable apparatus may comprise or be connected to a glove. Preferably, the first wearable sensor apparatus is worn on a hand of the user, for example on the wrist or on the finger of the user. The wearable sensor apparatus comprises an IMU. The first wearable sensor apparatus may comprise a transceiver for transmitting and receiving data. Such a transceiver may be used for example, for transceiving data between a controller and the first wearable sensor apparatus, and/or for example for transceiving data between the first wearable sensor apparatus and the second sensor apparatus. The first wearable sensor apparatus may comprise circuitry configured to measure the user using the IMU, and provide the data to another apparatus such as the controller and/or the second apparatus. The first wearable sensor apparatus may be a hand wearable device. For example, the first wearable apparatus may comprise or be connected to a glove.

The term second sensor apparatus refers to a device which is not necessarily wearable. It may be also referred to as a reference point apparatus, an anchor device or a reference device. The second sensor apparatus may be configured to provide a frame of reference for the first wearable sensor apparatus. The second sensor apparatus therefore provides a reference point for the measurements taken by the first wearable sensor apparatus. The second apparatus may be a smartphone. The second apparatus may be a wearable apparatus. For example, the user may wear the second apparatus on an extremity of the user, for example, foot, leg, head, arm, hand, palm, back of a hand, wrist or finger of the user. The second sensor apparatus may comprise a mounting component, such as a strap, a vest, a hat, or a cap so as to attach the second sensor apparatus to a part or portion of the user. The second sensor apparatus comprises an IMU. The IMU may be for example attached to the torso or the head of the user thereby providing orientation and/or motion of said IMU. The second sensor apparatus may be configured to at least measure the distance to the first wearable sensor apparatus, based on for example, ultrawideband, UWB, tracking.

A reference point or anchor point refers to a point provided by, for example, the second sensor apparatus based on which the first wearable apparatus is referenced. There may be a plurality of reference points. Such a plurality of reference points may be provided, for example, by a plurality of second sensor apparatuses.

A frame of reference refers to a coordinate system with respect to which the orientation and position of the first wearable sensor apparatus may be depicted. The frame of reference may be based on a reference point provided by a second sensor apparatus.

A spatial relation estimate refers to an estimate of movement, orientation and/or location of the first wearable sensor apparatus in with respect to at least one second sensor apparatus.

UWB refers to a radiofrequency system, such as a system utilizing ultrawideband, UWB. Such a system may be used to measure distance between an anchor point and wearable sensor apparatus.

A controller refers to a computing device. A controller is configured to compute the gesture of the user based on received data using a gesture classifier. The controller may comprise a transceiver configured for transmitting and receiving data, for example, transceiving data between the controller and the wearable sensor apparatus and/or between the controller and the second sensor apparatus. Controller may be configured to receive data, such as IMU data, from the first wearable sensor apparatus. In an embodiment, the first wearable sensor apparatus may comprise the controller. In another embodiment, the second sensor apparatus may comprise the controller.

A smart phone may comprise the controller. The smart phone may be arranged in clothing of the user, such as a pocket of the user. The smart phone may comprise the second sensor apparatus.

Inertial measurement unit, IMU, refers to an apparatus configured to measure at least one of: specific force, angular rate, orientation of the IMU. The IMU may be configured to provide position information of an apparatus. The IMU may be configured to provide position information of the at least part of the system or a part of the user's body whereon the IMU is mounted, attached or worn. At least some embodiments are configured to measure the position and/or movement of the user by using the IMU. The IMU may be termed an inertial measurement unit sensor. The IMU may comprise at least one of the following: a multi-axial accelerometer, a gyroscope, a magnetometer, an altimeter, a barometer. It is preferable that the IMU comprises a magnetometer as the magnetometer provides an absolute reference for the IMU. A barometer, which is usable as an altimeter, may provide additional degrees of freedom to the IMU. In an embodiment, the IMU is an IMU with six degrees of freedom 6-DOF, also known as a 6-axis IMU.

The IMU is configured to send a sensor data stream, for example to an internal or external controller. Said sensor data stream comprises, for example, at least one of the following: multi-axial accelerometer data, gyroscope data, and/or magnetometer data. The IMU and a controller may be located on the same PCB (printed circuit board). Changes in the IMU data reflect, for example, movements and/or actions by the user, and thus such movements and/or actions may be measured by using the IMU data. The IMU signal frequency may be from 50 Hz to 150 Hz, for example 100 Hz.

Regarding the IMU, the IMU may be adjusted, for example by a apparatus connected to the IMU, before or after preprocessing. Such adjustment may be self-referential, e.g. the sensor is adjusted or calibrated according to a stored reference value or a known good (e.g. magnetic north for the IMU).

From an inertial measurement unit, IMU, a gravity vector may be obtained. By comparing such obtained gravity vectors from two or more IMUs, such as the IMU of the first wearable sensor apparatus and IMU of the second sensor apparatus, orientation of the first wearable sensor apparatus may be obtained.

In some embodiments, a wearable sensor apparatus comprises a plurality of additional sensors, said additional sensor being additional to that of the IMU of the wrist wearable sensor apparatus.

Optical sensor may be an additional sensor. Such a sensor may be a photoplethysmogram (PPG) sensor.

An electrophysiological sensor may be an additional sensor. Such a sensor may be an electromyogram (EMG) sensor.

A barometer may be an additional sensor. Barometer refers to an apparatus configured to measure air pressure in an environment.

Motion features refer to information of motion related to at least one of: temporal, frequency or axis information of the IMU of the wearable sensor apparatus.

Axis specific motion feature refers to a motion feature, that provides information on motion along an axis. Information on motion features along one of: palmar-dorsal axis, ulnar-radial-axis and up-down axis, are examples of axis-specific motion features. Axis-specific motion feature may be, for example, acceleration and/or velocity along the palmar/dorsal, ulnar/radial, and up/down axes.

Hand and forearm dynamics refer to constraints for hand and forearm. As two are connected via the wrist, the feasibility distance of the two, velocity difference between them etc are depicted with hand and forearm dynamics.

Gesture classifier refers to a computational component, for example part of the controller, configured to classify a gesture, based on at least data from the wearable device. The gesture classifier obtains at least one motion feature from the wearable sensor apparatus, and based on the obtained motion feature, determines a gesture. In an embodiment, the gesture classifier is configured to provide as an output, a list of probabilities or a classified gesture based on at least the data from the wearable sensor apparatus. In an embodiment, the gesture classifier is configured to determine whether the hand of the user is in a gesture state, for example a pinch state, or not in a gesture state. The determination may be performed by detecting and classifying gesture transitions based on transients within the received data. In an embodiment comprising an anchor device, the gesture classifier may receive spatial relation information depicting the spatial relation of the wearable sensor apparatus in a frame of reference.

The gesture classifier may comprise an artificial neural network, termed as a “neural network classifier”, configured to at least in part provide a list of probabilities for a user gesture.

The measurement, such as the IMU measurement, may be temporally windowed so as to provide information on movement of the user or part thereof, for example, the torso or an extremity of the user. In an embodiment, an adaptive time window is used as part of the gesture classification.

Determined user gesture A determined user gesture may be provided by the gesture classifier as an output. The classified gesture may be based on a list of probabilities. The determined user gesture may be an assumption of a gesture, for example, based on a list of probabilities of the gesture of the user.

A gesture classifier provides a list of probabilities depicting the probability of a gesture based on the measured data from the wearable device.

Candidate gestures may be provided by a gesture classifier. Candidate gestures refer to a list of pairs depicting gestures with respective probabilities thereof. For example, a list of gestures may contain “hand wave-50%”, “shake-30%”, “thumbs up-15%” and “no gesture-5%”.

Affordance means a logical constraint used to improve inference. Such logical constraints may depend on the context, such as geographical location of the user and/or constraints with respect to a motion feature, such as maximum possible acceleration.

An affordance profile relates to a user interface. An affordance is a possible action the user may perform in the context of the user interface. An affordance profile may comprise a list of the possible actions the user may perform. If the user interface, for example in a user interface state, does not provide the user with the option to perform a certain action, then the gesture interpreter may be configured to rank that certain action as less likely to be performed. For example, if the user has scrolled to the end of a video, it is not possible to continue scrolling in the same direction. An affordance profile may be used, for example by a interaction interpreter, to increase the accuracy of detecting an action, when the application can predict what kind of action the user is likely to perform next. For example, the user cannot accelerate at 100 km/h.

A user intent estimate relates to the user interface. The user intent estimate is based on the repetitive and/or logical nature of most user interfaces. For example, when the user is shown a list, often said user will want to scroll down the list. Then, the user may want to either exit the list or scroll back up the list, or select an item on the list. An user intent estimate may comprise a list of the probable actions the user may perform, for example ranked by probability. Each user intent estimate may be related to a certain user interface and/or certain user interface state. For example, the user intent estimate may change depending on the application being executed by the controllable apparatus. A intent estimate may comprise an indication of future actions, and/or information related to a set of suitable actions with respect to contextual information. For example, the scene may provide information related to a previous action (for example “playing a video”) and an expected future action (for example “pausing a video”, “adjusting volume”).

The output of the gesture interpreter may be an intent estimate, which provides an estimate for a gesture. The intent estimate may be provided to an interaction/state interpreter as input. The intent estimate may be logically determined based on a previous action. For example, if the user raises his hand, he will most likely lower it later.

Contextual information may be scene-based contextual information and/or gesture-related information.

The output of the gesture classifier, such as a list of probabilities, may be post-processed by a gesture interpreter. Such an interpreter determines the user gesture, which is then compared, by the gesture interpreter for example, contextual information, or to an affordance profile, such that a determined user gesture may be provided.

In embodiments, apparatuses may be connected to each other using skin surface electrical connections, for example using body coupled communication, for example using 1 to 50 MHz frequency, for example 3.25 MHz with 1 MHz bandwidth, or for example 13.56 MHz or 23 MHz. Apparatuses may comprise the necessary electrodes to facilitate skin surface electrical communication.

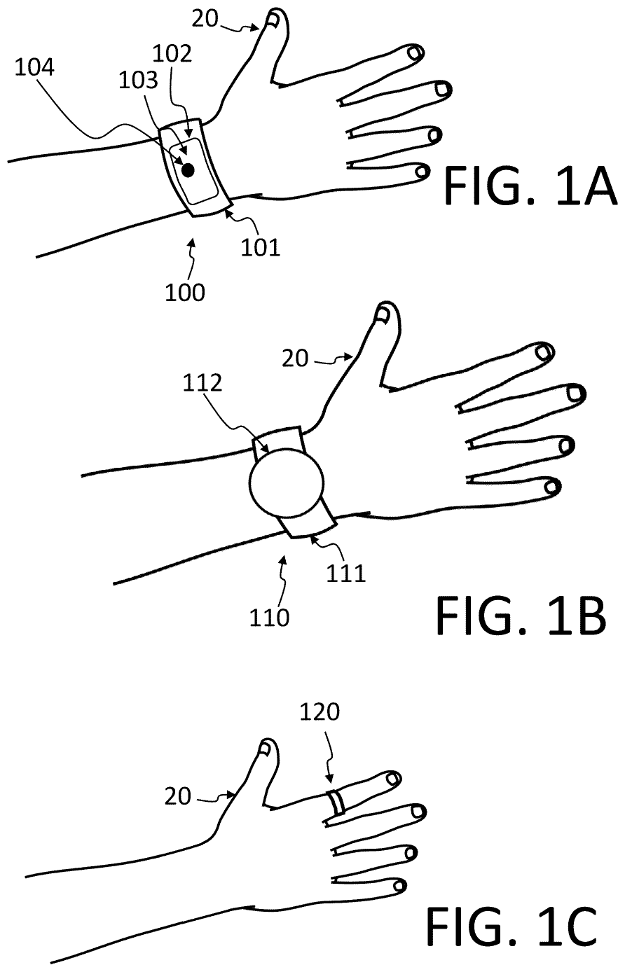

FIGS. 1A, 1B and 1C illustrate exemplary embodiments of apparatuses capable of supporting at least some of the embodiments of the present disclosure.

In FIG. 1A, apparatus 100 is shown being worn by user 20. Apparatus 100 is a wrist-wearable apparatus, for example a wristband. Apparatus 100 comprises mounting component 101, for example a strap. Apparatus 100 comprises a housing 202, wherein an inertial measurement unit sensor, IMU, 104 is located within the housing. Further, controller 1 may be located within the housing.

The IMU 104 may be configured to provide a sensor data stream. The providing may be within the apparatus, for example to a controller, a digital signal processor, DSP, a memory. Alternatively or additionally, the providing may be to an external apparatus. A sensor data stream may comprise one or more raw signals measured by sensors. Additionally, a sensor data stream may comprise at least one of: synchronization data, configuration data, and/or identification data. Such data may be used by the controller to compare data from different sensors, for example.

The controller 103 comprises at least one processor, and at least one memory including computer program code, and optionally data. Controller 103 may be configured to communicate with IMU 104, so as to at least receive data streams from the IMU. In other words, the controller 103 may be configured so as to cause the controller to receive at least one sensor data stream from at least one sensor, for example the IMU. The IMU signal frequency may be from 50 Hz to 150 Hz, for example 100 Hz. In some embodiments, the controller 103 is a minimal controller, configured only to transmit data corresponding to the IMU 104 data stream to another device for processing.

Alternatively or additionally, the controller 103 may perform more complex tasks, as discussed hereafter. The controller 103 may be configured to perform preprocessing on at least one received sensor data streams, wherein the preprocessing may comprise the preprocessing disclosed herein. The controller 103 may be configured to process the received at least one sensor data stream from the at least one sensor. The controller 103 may be configured to: receive data from the first wearable sensor apparatus, the data comprising measured IMU data related to a user gesture, the user gesture comprising at least one motion feature, receive data from a second sensor apparatus, the data comprising IMU data, for example UWB data, barometer data, for example several cases comparative data based at least in part on data from both the first and the second sensor apparatuses, compute at least one motion feature based at least in part on the received data from the first wearable sensor apparatus, the computing based at least in part on the received data from the first wearable sensor apparatus and the received data from the second sensor apparatus, provide the computed at least one motion feature to a gesture classifier, determine, using the gesture classifier, the user gesture based at least in part on the computed at least one motion feature, and output the determined user gesture.

The controller 103 may comprise the gesture classifier in the form of a trained machine learning model, for example at least one neural network.

The controller 103 may be configured to generate, based on the characteristics of the processed sensor data stream, at least one user interface event and/or command. The controller may be configured to transmit the UI event and/or command based on the output gesture. The UI event and/or command may be at least one of: a an indication corresponding to the performed gesture, and/or directional movement, adjusting a slider, raising or lowering volume, and/or media controls.

The controller 103 may be configured so that the movement information comprises at least one data signal within a time window, and wherein the classifier is configured to classify the gesture based on the motion features within said time window, for example so that the classifier is configured to classify the gesture and optionally any subsequent gestures based on at least one motion feature, for example hand velocity along an axis within said time window. For example, if an accelerometer signal increases over a certain threshold (for example 10%-100% increase) within a short time (for example less than 50% to 10% of the time window), then that would qualify as a suitable motion feature for gesture classification. The time window may be predetermined, or set by the controller 103. A suitable time window may be from 50 milliseconds to 500 milliseconds, in particular 400 milliseconds.

The controller 103 may be configured so that the gesture classifier comprises a trained machine learning model, for example a trained neural network, wherein the trained machine learning model is trained to classify gestures as candidate gestures based on movement information. Such a trained machine learning model may comprise transformers, a recurrent neural network, and/or a convolutional neural network. The model may be trained using supervised training (labeled) data, augmented data, foundational models. The trained machine learning model may be configured to further learn from the user's gestures when using controller 103.

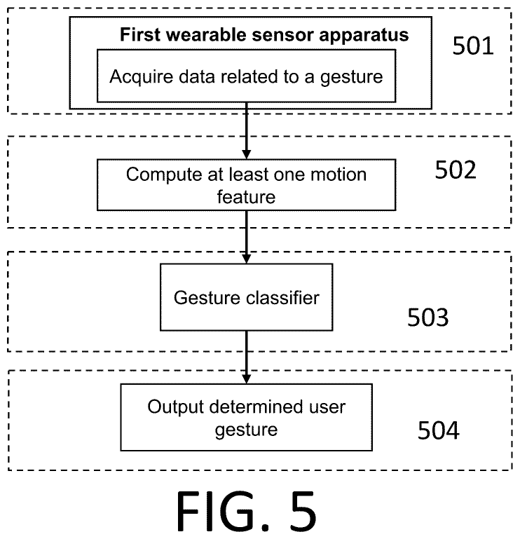

The controller 103 may be configured so that the gesture classifier comprises a rule-based model, wherein the rule-based model is trained to classify gestures as candidate gestures based on movement information according to rules, the rules being related to signal characteristics, for example signal intensity, of the movement information. Signals may be observed in FIG. 5, which may display typical signals of gestures in accordance with the present disclosure.

The apparatus 100 may further comprise a communication unit or interface, for example located within the housing. Such a unit may comprise, for example, a wireless and/or wired transceiver. Apparatus 100 may comprise a power source, for example a battery, arranged to power the components of the apparatus.

The controller 103 may be configured to execute a low level model, the low level model configured to activate the gesture classification when the low level model detects the user movement is being performed. In other words, the low level model may wake the gesture classifier when a gesture is detected by the low level model. Detection, by the low level model, may be based on an analysis of the IMU signal. The low level model may be constantly executed by the controller, as it does not need as much computational or electrical power as the classifier. The low level model is responsive enough to wake the classifier in time to classify a gesture being performed, even if the classifier was not awake when the gesture was begun by the user. Optionally, the gesture classification may be activated manually or based on a condition. Such a condition may comprise at least one of the following: a user voice command, a user wake gesture, a UI event (for example a phone notification), shaking the controllable device, or shaking the controller.

The controller 103 may be configured to perform onboard processing, said onboard processing comprising at least one of: preprocessing of the IMU signals, motion feature computation or gesture classification.

FIG. 1B illustrates an example system comprising a wearable apparatus 110, wherein said wearable apparatus is a watch, for example a smartwatch, comprising a strap mounting component 111. Apparatus 110 further comprises an IMU (not shown), arranged as at least one of: as a part of the mounting component, attached to the mounting component, within the watch housing 112, or attached to said housing 112. Apparatus 110 may comprise a controller comprising a processor, memory and communications interface. The controller may be configured to perform the methods disclosed herein, in particular any functions described in connection with apparatus 100.

The apparatus 110 may further comprise a communication unit or interface, for example located within the housing. Such a unit may comprise, for example, a wireless and/or wired transceiver. Apparatus 110 may comprise a power source, for example a battery, arranged to power the components of the apparatus.

FIG. 1C illustrates an example system comprising a wearable apparatus 120, wherein said wearable apparatus comprises a ring-shaped mounting component. Apparatus 120 further comprises an IMU (not shown), either within the ring-shaped mounting component or attached thereto. Apparatus 120 may comprise a controller comprising a processor, memory and communications interface. The controller may be configured to perform the methods disclosed herein, in particular any functions described in connection with apparatuses 100 and/or 110.

The apparatus 120 may further comprise a communication unit or interface, for example located within the housing. Such a unit may comprise, for example, a wireless and/or wired transceiver. Apparatus 120 may comprise a power source, for example a battery, arranged to power the components of the apparatus.

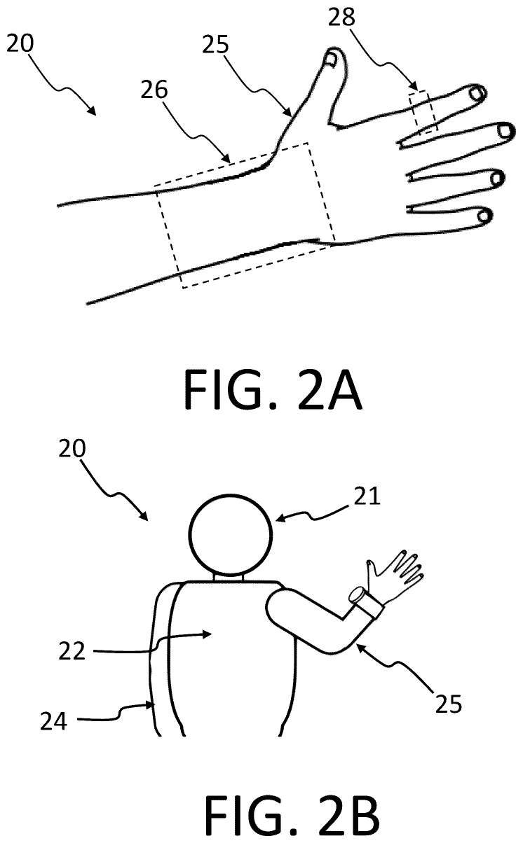

FIGS. 2A and 2B illustrate the biology of a user in accordance with at least some embodiments of the present disclosure. A user 20 has a hand 25. The user's hand may comprise several areas of interest as shown in the figures, for example wrist area 26, finger area 28.

The user has a wrist area 26. Wrist area 26 is suitable for wearing an apparatus, for example an apparatus 110. Importantly, such an apparatus may detect the directional user gestures from the wrist area. The wrist area 26 may comprise, for example, an area starting from a bottom end of the palm of the user and ending a few centimeters below the bottom end of the palm of the user. When the user performs an action with the hand connected to the wrist, a sensor device arranged, for example worn, in the vicinity of the wrist area 26 may detect signals such as movements of the hand muscles and/or tendons. In other words, the wrist reacts in a measurable way to gestures, and the measurements (taken with an apparatus configured according to the present disclosure) correspond to specific directional movements. Measurements may be taken continuously, for example from the wrist area, to provide sensor data which can be used by the embodiments.

Finger area 28 is the surface of any of the distal, medial and/or proximal phalanx of the user's finger. Finger area 28 is suitable for wearing an apparatus, for example an apparatus 120. Importantly, such an apparatus may detect the directional user gestures from the finger area. When the user performs an action with the hand connected to the finger, a sensor device arranged, for example worn, in the vicinity of the finger area 28 may detect signals such as movements of the hand muscles and/or tendons. In other words, the hand reacts in a measurable way to gestures, and the measurements (taken with an apparatus configured according to the present disclosure) may correspond to specific movements. Measurements may be taken continuously, for example from the finger area, to provide sensor data which can be used by the embodiments.

In FIG. 2B, the user's upper body is shown. The upper body of user 20 comprises head 21, torso 24, hand 24 and other hand 25. References to head or torso may include the back or front of said body parts.

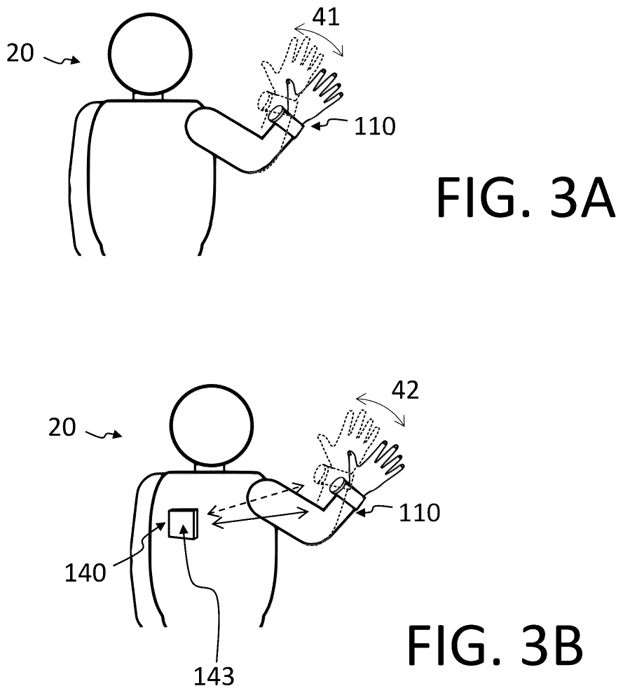

FIGS. 3A and 3B illustrate exemplary embodiments of apparatuses and/or systems capable of supporting at least some of the embodiments of the present disclosure.

In FIG. 3A, apparatus 110 is shown being worn by user 20 on the wrist of the user 20. The user 20 is performing a gesture 41. Data related to gesture 41 is acquired by the apparatus 110. Apparatus 110 may be termed a first wearable sensor apparatus 110. The term “first” with respect to “wearable sensor apparatus” is intended only to provide clarity for the reader and is in no way to be considered as limiting. The system shown in FIG. 3A comprises at least apparatus 110.

Apparatus 110 comprises at least one IMU, said IMU being comprised in or attached to the apparatus 110. The IMU is configured to provide IMU data, for example relating to the movements, for example hand movements, of the user. Wearable sensor apparatus is configured to communicate with at least one controller, where said communication comprises, for example transceiving data related to the IMU movement measurement. For example, the communication may comprise sending the IMU data relating to a measured movement and/or time period to the controller.

Apparatus 110 may comprise a controller, such as controller 103. Controller of apparatus 110 may comprise at least one processing core, at least one memory including computer program code; the at least one memory and the computer program code being configured to, with the at least one processing core, cause the controller at least to compute at least one motion feature based at least in part on the received data from the wearable sensor apparatus, the computing based at least in part on the received data from the first wearable sensor apparatus, provide the computed at least one motion feature to a gesture classifier, determine, using the gesture classifier, the user gesture based at least in part on the computed at least one motion feature, and output the determined user gesture.

Additionally or alternatively, apparatus 110 may be configured to communicate with a separate controller, which may be configured to perform tasks as discussed in connection with controller 103. This separate controller may comprise at least one processing core, at least one memory including computer program code; the at least one memory and the computer program code being configured to, with the at least one processing core, cause the separate controller at least to compute at least one motion feature based at least in part on the received data from the wearable sensor apparatus, the computing based at least in part on the received data from the first wearable sensor apparatus, provide the computed at least one motion feature to a gesture classifier, determine, using the gesture classifier, the user gesture based at least in part on the computed at least one motion feature, and output the determined user gesture.

Apparatus 110 is configured to at least participate in classifying the user gesture, based on motion features within the IMU data measured by apparatus 110 during the gesture, wherein participation may mean transmitting data to a separate apparatus.

In FIG. 3B, apparatus 110 is shown being worn by user 20. The user is also in the vicinity of second sensor apparatus 140, which is shown to be located on or near to the user's torso. For example, the second sensor apparatus 140 may be attached to the user 20, or clothing of the user, such as a vest. The second sensor apparatus 140 may be configured to provide a reference point for the first wearable sensor apparatus 110. The user 20 is performing a gesture 42. The system shown in FIG. 3A comprises at least apparatus 110 and apparatus 140.

Second sensor apparatus 140 comprises a housing (not shown), wherein an inertial measurement unit sensor, IMU, is located within the housing. Further, controller 143 may be located within the housing.

In embodiments, the second sensor apparatus 140 may be wearable. In embodiments, the second sensor apparatus 140 may be portable. A portable second sensor apparatus may be placed in the pocket of the user, for example. In embodiments, the second sensor apparatus 140 may be, for example, a smartphone. For example, the user may place apparatus 140 in a pocket of a garment or a carrying apparatus such as a backpack. In some embodiments, apparatus 140 comprises a mounting component, for example a strap. While it is beneficial to attach the second sensor apparatus to the user in some manner, second sensor apparatus may be used while detached from the user, as long as it is physically somewhat close to the user, for example within 50 meters, preferably less than 25 meters.

The IMU of apparatus 140 may be configured to provide a sensor data stream. The providing may be within the apparatus 140, for example to a controller, a digital signal processor, DSP, a memory. Alternatively or additionally, the providing may be to an external and/or separate apparatus. A sensor data stream may comprise one or more raw signals measured by sensors. Additionally, a sensor data stream may comprise at least one of: synchronization data, configuration data, and/or identification data. Such data may be used by the controller, for example within apparatus 140, to compare data from different sensors, for example.

Using a second sensor apparatus is beneficial as certain gestures may be difficult to detect based on the data from only a single first wearable sensor apparatus. As such, in at least some embodiments, a reference point provided by a second sensor apparatus, to which the first wearable sensor apparatus is compared, is utilized. The reference point, especially when located on any of the chest, head, torso and/or belt of the user, allows to detect movements of the user's extremities, for example a hand, relative to the reference point provided by the apparatus.

In at least some embodiments, the second sensor apparatus is arranged to measure orientation and/or position of a part of the user, such as the torso of the user. For example, the second sensor apparatus may be attached to the chest of the user thereby measuring movement related to motion of the chest of the user, and/or providing reference data related to the position of the chest of the user relative to other body parts.

The second sensor apparatus 140 may comprise a sensor element. The sensor element may be at least one of: an inertial measurement unit, IMU, or an ultra-wideband, UWB, antenna. At least part of the sensor data from the second sensor apparatus may be comparative to at least part of the sensor data from the first wearable sensor apparatus. In other words, such comparative data from the second sensor apparatus and the first wearable sensor apparatus may be obtained with a similar, or corresponding sensor or sensor type or a plurality thereof. Therefore, comparative data may be used to obtain information on the relative positions, or changes therein, of the first wearable sensor apparatus and the second sensor apparatus. Comparative data may be used to calculate a gravity vector.

In at least some embodiments, the reference point for the first wearable sensor apparatus is configured to be obtained using at least ultrawideband, UWB, tracking. In UWB tracking, the first wearable sensor apparatus and the second sensor apparatus both comprise a UWB antenna configured to communicate with one another. A UWB antenna may also be known as a UWB device. Based on, for example, the signal strength and/or the time-of-flight, TOF, of the transmitted and received UWB signals between the two UWB antennae, the distance between the first wearable sensor apparatus and the second sensor apparatus may be estimated.

In at least some embodiments, the reference point for the first wearable sensor apparatus is configured to be obtained using at least barometer data, wherein the first wearable sensor apparatus and the second sensor apparatus both comprise a barometer. Based on, for example, the measured air pressure difference between the barometers, an altitude difference of the barometers, and thus at least in part spatial relation, of the first wearable sensor apparatus and the second sensor apparatus may be estimated.

In at least some embodiments, the reference point for the first wearable sensor apparatus is configured to be obtained using at least magnetometer data, wherein the first wearable sensor apparatus and the second sensor apparatus both comprise a magnetometer. Based on, for example, the difference in magnetometer data, orientation difference of the magnetometers, and thus at least in part spatial relation, of the first wearable sensor apparatus and the second sensor apparatus may be estimated.

In at least some embodiments, there are a plurality of reference points, provided by one or more second sensor apparatuses.

The controller 143 comprises at least one processor, and at least one memory including computer program code, and optionally data. Controller 143 may be configured to communicate with the IMU of apparatus 140, so as to at least receive data streams from the IMU. In other words, the controller 143 may be configured so as to cause the controller to receive at least one sensor data stream from at least one sensor, for example the IMU. The IMU signal frequency may be from 50 Hz to 150 Hz, for example 100 Hz. In some embodiments, the controller 143 is a minimal controller, configured only to transmit data corresponding to the IMU data stream to another device for processing.

Alternatively or additionally, the controller 143 may perform more complex tasks, as discussed hereafter. The controller 143 may be configured to perform preprocessing on at least one received sensor data streams, wherein the preprocessing may comprise the preprocessing disclosed herein. The controller 143 may be configured to process the received at least one sensor data stream from the at least one sensor. The controller 143 may be configured to: receive data from the first wearable sensor apparatus, the data comprising measured IMU data related to a user gesture, the user gesture comprising at least one motion feature, receive data from a IMU comprised in the second sensor apparatus, the data comprising IMU data, for example UWB data, barometer data, for example several cases comparative data based at least in part on data from both the first and the second sensor apparatuses, compute at least one motion feature based at least in part on the received data from the first wearable sensor apparatus, the computing based at least in part on the received data from the first wearable sensor apparatus and the received data from the second sensor apparatus, provide the computed at least one motion feature to a gesture classifier, determine, using the gesture classifier, the user gesture based at least in part on the computed at least one motion feature, and output the determined user gesture.

The controller 143 may comprise the gesture classifier in the form of a trained machine learning model, for example at least one neural network.

The controller 143 may be configured to generate, based on the characteristics of the processed sensor data stream, at least one user interface event and/or command. The controller may be configured to transmit the UI event and/or command based on the output gesture. The UI event and/or command may be at least one of: a an indication corresponding to the performed gesture, and/or directional movement, adjusting a slider, raising or lowering volume, and/or media controls.

The controller 143 may be configured so that the movement information comprises at least one data signal within a time window, and wherein the classifier is configured to determine the gesture based on the motion features within said time window, for example so that the classifier is configured to classify the gesture and optionally any subsequent gestures based on at least one computed and/or observed motion features within said time window. For example, if an accelerometer signal increases over a certain threshold (for example 10%-100% increase) within a short time (for example less than 50% to 10% of the time window), then such a motion feature may be used for classification. The time window may be predetermined, or set by the controller 103. A suitable time window may be from 50 milliseconds to 500 milliseconds, in particular 400 milliseconds.

The controller 143 may be configured so that the gesture classifier comprises a trained machine learning model, for example a trained neural network, wherein the trained machine learning model is trained to classify gestures as candidate gestures based on movement information. Such a trained machine learning model may comprise transformers, a recurrent neural network, and/or a convolutional neural network. The model may be trained using supervised training (labeled) data, augmented data, foundational models. The trained machine learning model may be configured to further learn from the user's gestures when using controller 143.

The controller 143 may be configured so that the gesture classifier comprises a rule-based model, wherein the rule-based model is trained to classify gestures as candidate gestures based on movement information according to rules, the rules being related to signal characteristics, for example signal intensity, of the movement information. Signals may be observed in FIG. 5, which may display typical signals of gestures in accordance with the present disclosure.

The apparatus 140 may further comprise a communication unit or interface, for example located within the housing. Such a unit may comprise, for example, a wireless and/or wired transceiver. Apparatus 140 may comprise a power source, for example a battery, arranged to power the components of the apparatus.

The controller 140 may be configured to execute a low level model, the low level model configured to activate the gesture classification when the low level model detects the user movement is being performed. In other words, the low level model may wake the gesture classifier when a gesture is detected by the low level model. Detection, by the low level model, may be based on an analysis of the IMU signal, for example a signal from the first wearable sensor apparatus. The low level model may be constantly executed by the controller, as it does not need as much computational or electrical power as the classifier. The low level model is responsive enough to wake the classifier in time to classify a gesture being performed, even if the classifier was not awake when the gesture was begun by the user. Optionally, the gesture classification may be activated manually or based on a condition. Such a condition may comprise at least one of the following: a user voice command, a user wake gesture, a UI event (for example a phone notification), shaking the controllable device, or shaking the controller.

The controller 143 may be configured to perform onboard processing, said onboard processing comprising at least one of: preprocessing of the IMU signals, motion feature computation or gesture classification.

In an embodiment, the second sensor apparatus is wirelessly connected to the first wearable sensor apparatus. Alternatively, the second sensor apparatus may be electrically connected to the first wearable sensor apparatus. In an embodiment, the second sensor apparatus is connected via an electronic cable. In another embodiment, the second sensor apparatus is connected to the wearable device using electrical contact via the skin surface (epidermis) of the user.

In an embodiment, the first wearable sensor apparatus comprises a barometer and the second sensor apparatus comprises a barometer. Such embodiment may be beneficial in that altitude information may be determined, for example when hand up or down motion is being determined.

Based on the above discussion of FIGS. 3A and 3B, it is apparent that either the first wearable sensor apparatus, for example 110, or the second sensor apparatus 140 may comprise the controller of a system for classifying a user gesture based on motion features within the IMU data measured by at least one of apparatus 110 or 140 during the gesture. Further, a separate controller, not comprised in the first wearable sensor apparatus, for example 110, or the second sensor apparatus 140, may be used.

A system in accordance with the present disclosure may further utilize a plurality, for example two, wearable sensor apparatuses such as apparatus 110. Data from the second wearable sensor apparatus may be used for reference purposes, and/or to measure gestures performed by a second body part. The following tables illustrate various beneficial arrangements of the sensor, reference and controllers by listing the location of each. Each row in the table is an embodiment usable with the present disclosure.

TABLE 1
Wrist-based control

| Sensor | | Controller |
|---|---|---|
| location | Reference location | location |
| Wrist | Wrist | Wrist |
| Wrist | Torso (for example chest) | Wrist |
| Wrist | Other hand (for example finger, wrist) | Wrist |

When the sensor and reference as well as the controller are arranged in the same place (for example the wrist), benefits include simplicity and small form factor and no need for external communication. However, when the reference point is further away from the sensor, the quality of the comparative data is improved. Using a second hand-mounted device as the reference provides a benefit of being able to classify gestures performed by either hand, while still having a reference.

TABLE 2
Phone-based control

| Sensor | | Controller |
|---|---|---|
| location | Reference location | location |
| Wrist | Torso | Smartphone |
| Wrist | Smartphone | Smartphone |
| Wrist | Other hand (for example finger, wrist) | Smartphone |

Using a smartphone as a controller is beneficial because such devices typically have a lot of processing power as well as good connectivity. Using the smartphone itself as a reference point may simplify the system construction. However, a separate apparatus such as 140 or a hand-mounted apparatus used as a reference may be more rugged for practical applications. Again, incorporating a second hand-mounted device in the system provides a benefit of being able to classify gestures performed by either hand.

TABLE 3
Separate controller

| Sensor location | Reference location | Controller location |
|---|---|---|
| Wrist | Torso | Torso |
| Wrist | Smartphone | Torso |

Using a separate sensor apparatus such as 140 as a reference may be more rugged for practical applications. It may further have longer battery life and utilize communications which are not commonly provided in smartphones, for example wired connection to hand-mounted apparatuses. Using a smartphone as a reference for a second sensor apparatus may be useful as a contingency option, for example.

It is also possible to use finger mounted apparatuses, such as apparatus 120, in systems in accordance with the present disclosure.

TABLE 4
Finger-based control

| Sensor | | Controller |
|---|---|---|
| location | Reference location | location |
| Finger | Finger | Finger |
| Finger | Torso (for example chest) | Finger |
| Finger | Other hand (for example finger, wrist) | Finger |

When the sensor and reference as well as the controller are arranged in the same place (for example a finger), benefits include simplicity and small form factor and no need for external communication. However, when the reference point is further away from the sensor, the quality of the comparative data is improved. Using a second hand-mounted device as the reference provides a benefit of being able to classify gestures performed by either hand, while still having a reference.

TABLE 5
Phone-based control with finger

| Sensor | | Controller |
|---|---|---|
| location | Reference location | location |
| Finger | Torso | Smartphone |
| Finger | Smartphone | Smartphone |
| Finger | Other hand (for example finger, wrist) | Smartphone |

Using a smartphone as a controller is beneficial because such devices typically have a lot of processing power as well as good connectivity. Using the smartphone itself as a reference point may simplify the system construction. However, a separate apparatus such as 140 or a hand-mounted apparatus used as a reference may be more rugged for practical applications. Again, incorporating a second hand-mounted device in the system provides a benefit of being able to classify gestures performed by either hand.

TABLE 6
Separate controller with finger

| Sensor location | Reference location | Controller location |
|---|---|---|
| Finger | Torso | Torso |
| Finger | Smartphone | Torso |

Using a separate sensor apparatus such as 140 as a reference may be more rugged for practical applications. It may further have longer battery life and utilize communications which are not commonly provided in smartphones, for example wired connection to hand-mounted apparatuses. Using a smartphone as a reference for a second sensor apparatus may be useful as a contingency option, for example.

TABLE 7
Possible embodiments

| Sensor | | Controller |
|---|---|---|
| location | Reference location | location |
| Finger | Other hand (for example finger, wrist) | Torso |
| Wrist | Other hand (for example finger, wrist) | Torso |

The sensor location is beneficially hand-mounted to be able to detect hand gestures. Further, the controller function may be performed by a hand-mounted apparatus, a smartphone or a separate apparatus. This applies also to the reference apparatus function, which may be performed by a hand-mounted apparatus, a smartphone or a separate apparatus.

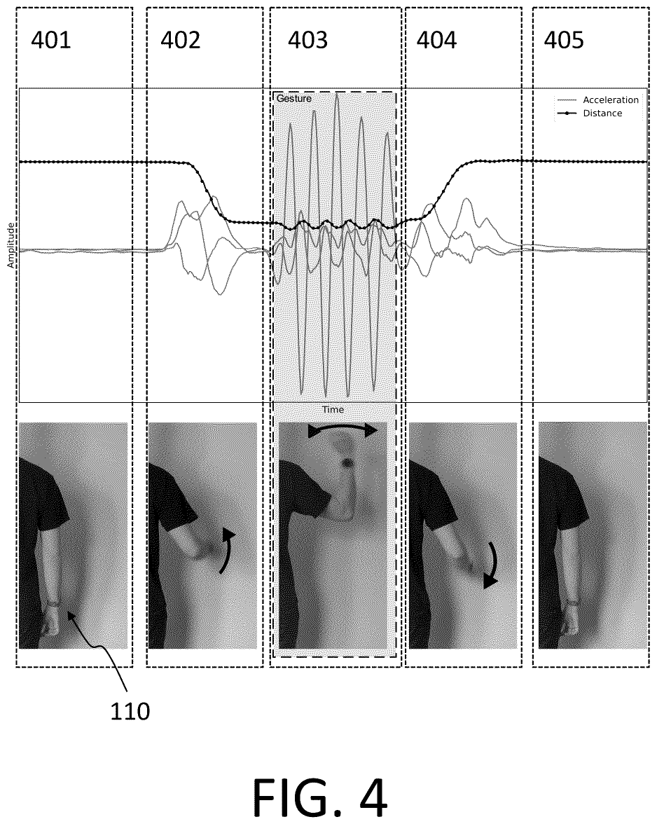

FIG. 4 illustrates a time versus amplitude signal plot, as measured by sensors, for example sensors of a first wearable sensor apparatus and a second sensor apparatus. In the example provided in FIG. 4, the first wearable sensor apparatus 110 is located at the wrist of the user. The second sensor apparatus is attached to, or is near, the head, upper torso or shoulder of the user (not explicitly illustrated in FIG. 4). The plot depicts raw sensor data from the respective sensors, that is, the UWB tracker (distance) and the IMU (acceleration). In at least some embodiments, such as the one illustrated in FIG. 4, the first wearable sensor apparatus comprises a first IMU and a first UWB antenna and the second sensor apparatus comprises a second IMU and a second UWB antenna. In FIG. 4, there is also illustrated, arm motion approximately corresponding to measured sensor data. For clarity, approximate phases 401, 402, 403, 404 and 405 are illustrated in FIG. 4 depicting approximate portions of the measured movement. As can be appreciated from the figure, raw data obtained from a sensor attached to a user's arm may at least in part correspond to arm motion and changes therein. Comparative data may be obtained by using raw data from at least two sensor apparatuses, for example a first wearable sensor apparatus and a second sensor apparatus.

In FIG. 4, the term “acceleration” refers to sensor data obtained from the first wearable sensor device, being in FIG. 4 a hand-wearable device. As can be appreciated from FIG. 4, 3-axis acceleration data is provided by the first wearable sensor apparatus on the user's wrist.

The term “distance” in FIG. 4, refers to sensor data correlating with the distance between a UWB antenna of the first wearable sensor apparatus and a UWB antenna of the second sensor apparatus. Thus, the second sensor apparatus provides a reference point for the first wearable sensor apparatus and measurements made therewith. In other words, the embodiment according to FIG. 4, employs UWB tracking. The second sensor apparatus, such as the one used in FIG. 4, may be attached to the torso or head of the user, for example.

In phase 401, the arm of the user is along the longitudinal axis of the user. As can be appreciated from phase 401 of FIG. 4, the distance measurements between the UWB antennae of the first wearable sensor apparatus and the second sensor apparatus is substantially constant with respect to time. Moreover, acceleration as measured by the first wearable sensor apparatus is substantially constant with respect to time.

In phase 402, the user lifts his arm by at least performing flexion of the arm from the elbow joint, and minutely from the shoulder joint. The movement of the first sensor apparatus occurring in phase 402 causes the distance of the first wearable sensor apparatus and the second sensor apparatus to change. Moreover, the measured acceleration is changed in terms of amplitude based on the direction of the movement.

In phase 403, the user has lifted his arm and performs a gesture, the gesture being a repetitive back-and-forth forearm, wrist and hand movement along the coronal plane. As can be appreciated from the measured sensor data, the acceleration component amplitudes change with respect to acceleration of the forearm and/or wrist of the user. In the UWB tracking, movement causes measurable changes in the distance between the first wearable sensor apparatus and the second sensor apparatus.

In phase 404, the user halts the gesture of phase 403, and begins to move his arm to the position along the longitudinal axis. Conversely to that of phase 402, the distance of the first wearable sensor apparatus and the second sensor apparatus begins to increase.

In phase 405, the arm of the user is along longitudinal axis which is at least in part observable as a substantially constant values of the acceleration and distance data.

In at least some embodiments, the raw data obtained from the first wearable sensor apparatus and the second sensor apparatus may be used to compute motion features. Such motion features may be inputted to a gesture classifier.

FIG. 5 illustrates an example process in flowchart form in accordance with at least some embodiments. Flowchart of FIG. 5 comprises phases 501, 502, 503 and 504 which illustrate at least some of the phases and/or steps for said process according to at least some embodiments.

In phase 501, the first wearable sensor apparatus, such as a hand-wearable apparatus, is configured to acquire data related to a gesture of the user. The first wearable sensor apparatus comprises an IMU. The data acquired is therefore at least IMU data, such as accelerometer data and/or gyroscope data. The first wearable sensor apparatus may comprise additional sensors to acquire data, such as an optical sensor, or an EMG sensor, for example.

In phase 502, at least one motion feature is obtained from at least the acquired data. For example, the at least one motion feature, may be an axis-specific motion feature, such as hand velocity along an axis or hand movement. Hand movement may comprise, for example, hand pronation or supination, and/or arm flexion or extension. A motion feature subsystem may compute the at least one motion feature.

In phase 503, the at least one motion feature is provided as an input for a gesture classifier. The gesture classifier is configured to provide a probability listing of gestures, based on the at least one motion feature. The listed probabilities may comprise one or more pairs of a predefined gesture paired with the corresponding probability for said gesture obtained from the gesture classifier. Table 8 illustrates an exemplary list as an example regarding this and other embodiments.

TABLE 8
Exemplary list of candidate gestures with probability

| Gesture name | Probability |
|---|---|
| Hand wave (fingers extended) | 90 |
| Hand wave (fist clenched) | 50 |
| Pumping fist up | 20 |
| Pumping fist down | 15 |

In phase 504, the gesture is output, for example transmitted from the controller. Based on at least the output of the gesture classifier, a determined user gesture may be obtained. The determination may be based on affordance and intent estimate, related to, for example, the context of a gesture.

In at least some embodiments, the at least one motion feature may be obtained with respect to a reference point. Such a reference point may be obtained at least in part from a second sensor apparatus.

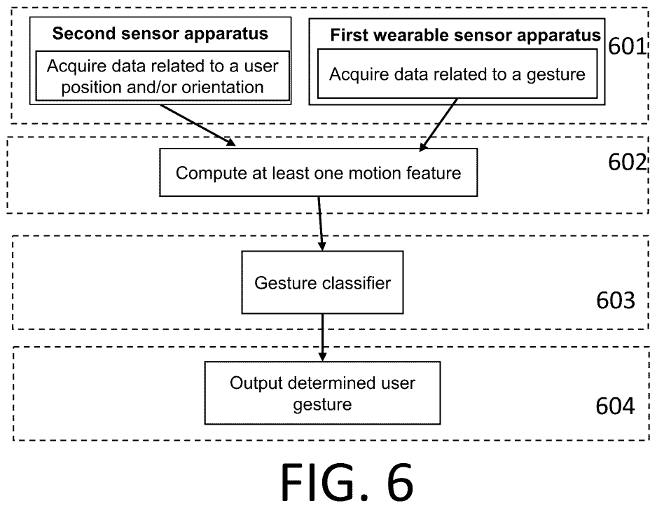

FIG. 6 illustrates a process in accordance with at least some embodiments.

In phase 601 of FIG. 6, data from two apparatuses is acquired. In this phase the controller, for example the controller 103, receives data, for example data streams, from one or both of the first wearable sensor apparatus and/or the second wearable sensor apparatus. The first wearable sensor apparatus, such as a hand-wearable apparatus, is configured to acquire data related to a gesture. The second sensor apparatus, for example a second wearable apparatus, is configured to acquire reference data in relation to the first wearable sensor apparatus. Such reference data may be data providing a reference in terms of orientation, distance, velocity and/or acceleration with respect to the first wearable sensor apparatus. For example, reference data may be from at least one of: barometer, magnetometer or ultrawideband signal.

In phase 602 of FIG. 6, the sensor data from the first wearable sensor apparatus and the second sensor apparatus are combined so as to compute at least one motion feature. The at least one motion feature, therefore, may take into account the spatial relation of the first wearable sensor apparatus and the second sensor apparatus.

In phase 603, the computed motion features are provided for a gesture classifier. The gesture classifier is configured to provide, as an output, a list of gesture probabilities.

In phase 604, based on at least the output of the gesture classifier, a determined user gesture is obtained.

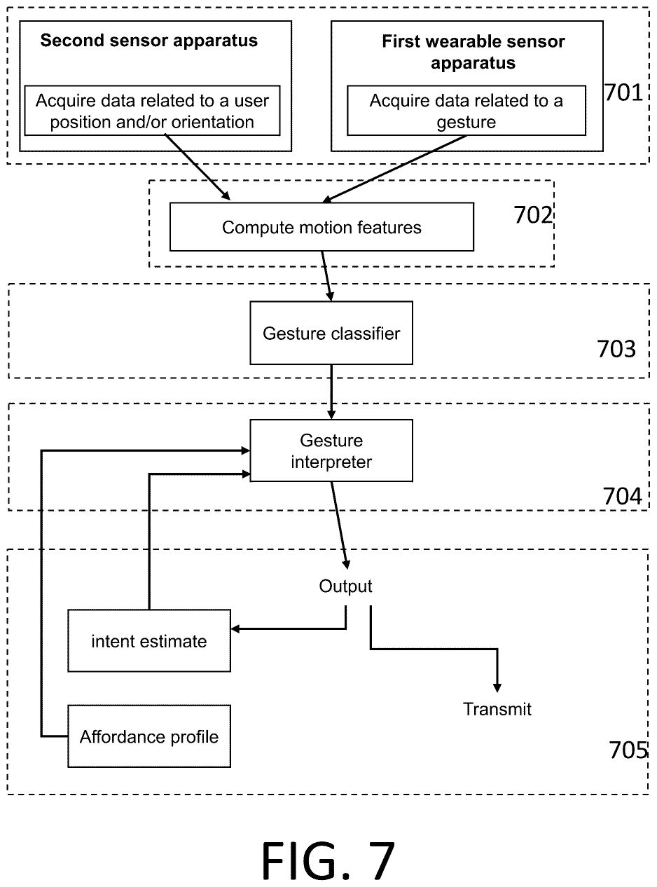

FIG. 7 illustrates in flowchart form an exemplary process capable of supporting at least some embodiments of the present disclosure. The process may be performed wholly or in part by any of apparatuses 100, 110, 120, 140, or by a smartphone.

At the top of FIG. 7, the first and second sensor apparatuses are shown. The actions and steps of the flowchart may be performed in least in part by an apparatus, for example a controller apparatus such as controller 103. At least some actions, such as providing data, may be performed by a sensor apparatus, such as one of sensor apparatuses 110, 120, for example.

The flowchart of FIG. 7 comprises illustrative but non-limiting phases 701, 702, 703, 704, and 705. Actions need not necessarily be within a phase. Further, the actions within phases 701, 702, 703, 704 and 705 need not be performed concurrently.

Phase 701 comprises data acquisition. In this phase the controller, for example the controller 103, receives data, for example data streams, from one or both of the first wearable sensor apparatus and/or the second wearable sensor apparatus. The sensor data may comprise, for example, IMU data. For example, the controller 103, may be configured to receive UWB data from the first wearable sensor apparatus and to receive UWB data from the second sensor apparatus.

As seen in the flowchart, after sensor data is received from the first wearable sensor apparatus, at least one motion feature may be computed based at least in part on said received sensor data. Phase 702 comprises the motion feature computation. A motion feature subsystem may be configured to compute at least one motion feature. The motion feature subsystem is configured to obtain signal streams of data.

The second sensor apparatus may be used as a reference point for the first apparatus. The data from the first wearable sensor apparatus and the data from the second sensor apparatus may be combined, using for example, sensor fusion. For example, hand position may be calculated based on the body position (kinematics). Distance between UWB devices may also be calculated, therefore providing a distance, or a distance estimate, between the first wearable sensor apparatus and the second wearable sensor apparatus. For the first wearable sensor apparatus and/or the second sensor apparatus, velocity and position may be calculated.

For example, based on the velocity of the first wearable in the frame of reference of the user's body (provided by the second apparatus), and estimate of the spatial relation between the devices may be performed.

The computing of the at least one motion feature may comprise computing axis-specific motion features, for example acceleration and velocity along the palmar/dorsal, ulnar/radial, and up/down axes. The at least one motion feature may be obtained in a hand frame of reference.

The computing of the at least one motion feature may comprise axis of rotation estimation, for example analyzing rotational velocity based on gyroscope data to determine angular motion, and correlating rotational velocity with acceleration vectors. The computing of the at least one motion feature may comprise obtaining a frame of reference from a hand-wearable apparatus, for example the user's hand's frame of reference.

The computing of the at least one motion feature may comprise temporal and/or frequency domain features, for example time-domain metrics comprising at least one of peak acceleration, velocity magnitude, and duration of motion events; and/or frequency-domain analysis comprising identification of periodic and/or oscillatory motion patterns, wherein the patterns may be associated with specific predetermined gestures.

Predetermined gestures are taught to the model or added as lookup table in rule-based system. The controller may comprise a motion feature library which is accessible by the motion feature subsystem. A key indicator may be a motion feature, and requirement(s) imposed thereon, that is used as a part of a rule for determining whether a specific gesture has been performed. A key indicator may be part of a plurality of gestures.

The at least one motion feature may be computed from raw data from at least one of: the first wearable sensor apparatus or the second wearable sensor apparatus. Such computation may include windowing, or buffering of measured raw data. The measured data may be used to obtain a motion feature from the raw data within said window. Such a window may be, for example, 500 milliseconds or 1000 milliseconds. The computation may be performed based on fused sensor data from a plurality of apparatuses, sensors and/or sensor elements. For example, the computation may be performed for IMU data from the first wearable sensor apparatus and IMU data from the second sensor apparatus. In another example, the computation may be performed for windowed data from the IMU and an optical sensor comprised in the first wearable sensor apparatus. In at least some embodiments, the windowing may comprise overlapping windowing, or sequential windowing, for example. For example, the motion feature algorithm may be ran every 0.05 seconds and it may have access to historical data of 0.6 seconds.

As seen in the flowchart, after the at least one motion feature is computed, the computed at least one motion feature is input into the gesture classifier in step 703. For example, a motion feature may be vertical hand acceleration. Such a feature may be calculated by a dedicated machine learning model or by an explicit rule. For example, a motion feature may be the maximum acceleration (either by total magnitude or along a specific axis) within the input time window, which could have a value of 20 m/s². A motion feature may also encode temporal characteristics of the sensor data. For example, characteristics such as statistical, spectral, or rate-of-change quantities computed over a time window of measured values. For example, a motion feature may be maximum acceleration of sensor which is 20 m/s2 downwards.

For example, the user may beckon with their hand in a “come here” movement. The gesture classifier may be configured to have the following criteria to satisfy such a movement: 1) Hand does not deviate from upward direction more than 20 degrees, 2) median velocity of hand in the palm direction is more than 0.5 m/s, 3) the absolute acceleration in other directions than palm direction is less than 3 m/s2, and 4) the speed of the hand towards a torso reference point is more than 0.3 m/s. When all four criteria are satisfied (i.e. computed from the measured data), the classifier may be configured to state that it was 95% likely the user has performed the “come here” gesture. This highlights the usefulness of the reference point provided by the second sensor apparatus.

The classifier then determines which predetermined gestures match the provided motion features. The classifier generates a list of predetermined gestures with the respective determined probability for each candidate gesture. The classifier outputs said list.

In phase 704, as seen in the flowchart, after a list of candidate gestures with the respective probability is generated, the generated list is provided to a gesture interpreter. In this phase, the output of the gesture classification is used to determine what the performed gesture was. The interpretation may comprise determining if the classification output is an acceptable result. For example, the interpretation phase may comprise evaluating the output of the gesture classifier against a threshold. If the output exceeds the threshold, then the output may be accepted as an output gesture. Further, the gesture interpreter may be configured to adjust the evaluation, for example raise or lower the threshold, based on at least one of an affordance profile and/or a user intent estimate.

An affordance profile relates to the user interface. An affordance is a possible action the user may perform in the context of the user interface. An affordance profile may comprise a list of the possible actions the user may perform. If the user interface, for example in a user interface state, does not provide the user with the option to perform a certain action, then the gesture interpreter may be configured to rank that certain action as less likely to be performed. For example, if the user has scrolled to the end of a video, in some cases it is not possible that the scrolling will continue in the same direction.

A user intent estimate relates to the user interface. The user intent estimate is based on the repetitive and/or logical nature of most user interfaces. For example, when the user is shown a list, often said user will want to scroll down the list. Then, the user may want to either exit the list or scroll back up the list, or select an item on the list. An user intent estimate may comprise a list of the probable actions the user may perform, for example ranked by probability. Each user intent estimate may be related to a certain user interface and/or certain user interface state. For example, the user intent estimate may change depending on the application being executed by the controllable apparatus. A intent estimate may comprise an indication of future actions, and/or information related to a set of suitable actions with respect to contextual information. For example, the scene may provide information related to a previous action (for example “playing a video”) and an expected future action (for example “pausing a video”, “adjusting volume”).

The affordance profile and/or the user intent estimate may be may be provided to gesture interpreter by the UI and/or by other sources, such as controller itself.

The output, in other words the determined gesture, may be provided as a confidence value, for example. The gesture interpreter may also output a null gesture. The output of the gesture interpreter may be used as basis for subsequent gesture selection (via the affordance and/or user intent).

The controller may provide the gesture to another application or apparatus or system.

In phase 705, the output of the gesture interpretation is transmitted, for example to a separate apparatus, for example to a server configured to retransmit outputted gestures. The outputted interpreted gesture may be provided via an API, for example. The outputted interpreted gesture may be provided for example in a format such as a boolean value and/or a HID, human interface device, frame.

As seen in the figure, the phase 705 may providing the intent estimate and/or the affordance profile to the gesture interpreter before or after the output is received from the interpreter.

FIG. 7A illustrates system 300 capable of supporting at least some embodiments of the present disclosure.

In FIG. 7A, an exemplary schematic view of system 300 is shown. As can be appreciated from FIG. 7A, the system 300 comprises the hand-wearable IMU 303, a reference IMU 304, and controller 301. A hand-wearable apparatus may comprise IMU 303. A second sensor apparatus, for example apparatus 140, may comprise reference IMU 304. Controller 301 is shown in the figure represented by the dotted line. As shown in the figure, controller 301 may comprise, for example in the memory of the controller, at least the preprocessing blocks 350, 330, and gesture classifier 380. Controller 301 may comprise gesture interpreter 390. System 300 may be configured so that at least one of: the gesture interpretation or the gesture transmission, is performed by controller 301.

IMU 303 is configured to transmit sensor data, for example in one or more sensor data streams, for example, the sensor data stream 313, respectively. The sensor data streams may be received by the controller 301. For example, sensor data stream 313 may comprise gyroscope data and accelerometer data. IMU 304 is configured to transmit sensor data, for example in one or more sensor data streams, for example, the sensor data stream 314, respectively. For example, sensor data stream 314 may comprise gyroscope data and accelerometer data. The sensor data streams may be received by the controller 301. The sensor data may be provided as a single stream, which the controller then separates. The sensor data streams 313, 314 may be optionally preprocessed.

Based at least in part on the sensor data streams 313, 314, the controller 301 may be configured to compute motion features of the gesture using motion feature subsystem 370. Such a subsystem may be a program, a function or a trained machine learning model within memory of controller 301. The computed motion features 306 may then be provided to gesture classifier 380. Alternatively or additionally, the computed motion features 306 may be provided to a separate apparatus.

Based at least in part on computed motion features 306, the controller 301 may be configured to classify the gesture using gesture classifier 380. The classified gesture 307 may then be provided to gesture interpreter 390. Alternatively or additionally, the classified gesture 307 may be provided to a separate apparatus. The form of classified gesture 307 may be a ranked list of probabilities corresponding to candidate gestures, for example candidate hand movements.

Controller 301 may be configured to interpret, using gesture interpreter 390, classified gesture 307. Controller 301 may output the interpreted gesture 309, for example to a separate apparatus, for example a server. Gesture interpreter 390 may be configured to utilize at least one of intent estimate or affordance profile in the interpretation. Intent estimate and/or affordance profile may be provided to gesture interpreter 390 by a separate apparatus and/or by other sources, such as controller 301 itself.

A controller, such as controller 103, controller 143 or controller 301, may comprise a classifier model. Such a model may comprise at least one of: algorithms, heuristics, and/or mathematical models. Such a model may be configured to classify a gesture, based on measurements obtained from a user and provided to the model. At least one confidence value, preferably a list and/or series of confidence values, may be output by the model, an apparatus or a system, based at least in part on the classification. At least one sensor data stream, such an IMU data stream, may be directed into at least one model. Such a model may include or be a machine learning model, comprising, for example, at least one neural network, such as a feed-forward, convolutional, recurrent or graph neural network, or. The model may additionally or alternatively comprise at least one of a supervised, unsupervised or reinforcement learning algorithm.

Neural networks disclosed herein may be any of, for example, a feed-forward neural network, a convolution neural network, or a recurrent neural network, or a graph neural network. A neural network may comprise a classifier and/or regression. The neural network may apply a supervised learning algorithm. In supervised learning, a sample of inputs with known outputs is used from which the network learns to generalize. Alternatively, the model may be constructed using an unsupervised learning or a reinforcement learning algorithm. In some embodiments, the neural network has been trained so that certain gestures correspond to certain computed motion features, for example a hand wave may correspond to a certain accelerometer signal.

A classifier model may comprise, for example, at least one convolutional neural network, CNN, performing inference on the input data, for example the signals received from the sensors and/or preprocessed data. Convolutions may be performed in spatial or temporal dimensions. Features (computed from the sensor data fed to the CNN) may be chosen algorithmically or manually. A classifier model may comprise a further RNN (recurrent neural network), which may be used in conjunction with a neural network to support motion feature computation based on sensor data which reflects user activity.

Feature extraction from input data may be done using a feature extraction module, which may comprise a neural network, for example a convolutional neural network. User actions, such as pinching in order to select an interactable element, may be identified using long short-term memory LSTM recurrent neural network RNN, for example. A system may further incorporate a feature extraction module configured to analyze the sensor data stream and identify additional user actions. Additional user actions may be, for example, selection gestures such as tap or pinch performed by the user's fingers.

Sensitivity of a gesture classification model, for example using a neural network, may be further adjusted based on a previous gesture history of a user. Such user specific adjustment of the gesture classification model may be done by, for example, adjusting some of the early and or late layers of the neural network. The previous gesture history, comprising at least one gesture performed by the user, of the user may be stored in an apparatus, such as a wrist-wearable apparatus or, for example, in a cloud-based storage system. Such a system may be configured to adjust the sensitivity and/or accuracy of the classification machine learning model based on a previous history of the user, for example a gesture history.

In accordance with this disclosure, the training of a model may be performed, for example, using a labelled data set containing IMU motion data from multiple subjects. This data set may be augmented and expanded using synthesized data. Depending on the employed model construction technique, the sequence of computational operations that compose the model may be derived via backpropagation, Markov-Decision processes, Monte Carlo methods, or other statistical methods. The model construction may involve dimensionality reduction and clustering techniques.

Gesture interpretation may utilize user intent information. The user intent estimate is based on the repetitive and/or logical nature of most user interfaces. A user intent estimate may comprise a list of the probable actions the user may perform, for example ranked by probability. Each user intent estimate may be related to a certain user interface and/or certain user interface state.

Gesture interpretation may utilize at least one affordance profile. An affordance profile may comprise a list of the possible actions the user may perform. If the user interface, for example in a user interface state, does not provide the user with the option to perform a certain action, then the gesture interpreter may be configured to rank that certain action as less likely to be performed. If, for example, a confidence level for a gesture is deemed high enough to be recognized as a gesture, but no action suitable for the gesture is available in the present UI state, such gesture may be on such occasion ranked lower or even disregarded.

The controller may be configured to generate a confidence level of a user gesture based on the received sensor data stream. The confidence level may comprise one or more indicated probabilities in the form of percentage values associated with one or more respective user gestures. The confidence level may comprise an output layer of a neural network. The confidence level may be expressed in vector form. Such a vector may comprise a 1×n vector, populated with the probability values of each user gesture known to the controller.

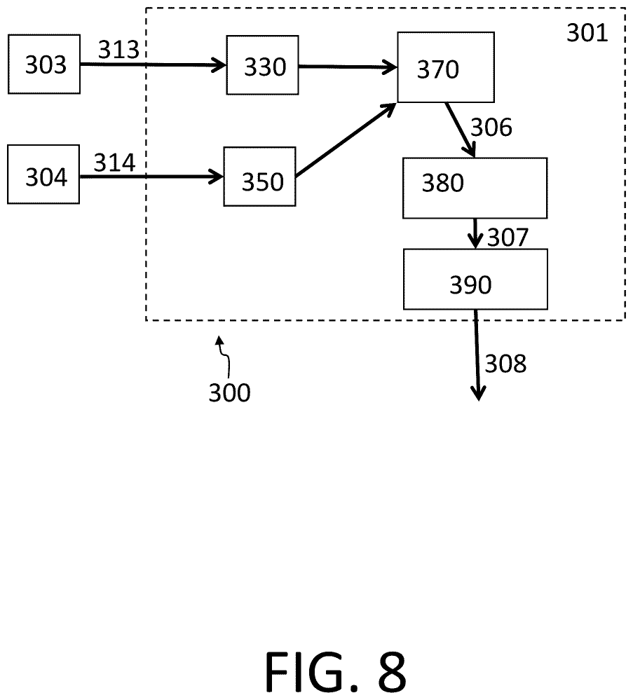

FIG. 8 illustrates a system 700 in accordance with at least some embodiments of the present disclosure. System 700 may comprise a trained machine learning model, for example a neural network. System 700 may further optionally comprise at least one of the following: an IMU 703, an IMU 704, a UWB apparatus 705.

The system 700 comprises a controller 702 comprising at least one processor 701, and at least one memory 707 including computer program code, and optionally data. The system 700 may further comprise a communication unit or interface.

Controller 702 may be connected to at least one sensor, for example sensor 703. Controller 702 may be connected to multiple sensors simultaneously, for example sensors 703, 704 and 705. An exemplary sensor may be an IMU. Controller 702 may be connected to said sensors directly, reserving communication interface for connections to other apparatuses, for example controllable devices.

Although the system 700 is depicted as including one processor, the system 700 may include more processors. In an embodiment, the memory is capable of storing instructions, such as at least one of: operating system, various applications, models, neural networks and/or, preprocessing sequences. Furthermore, the memory may include a storage that may be used to store, e.g., at least some of the information and data used in the disclosed embodiments.

Furthermore, the processor is capable of executing the stored instructions. In an embodiment, the processor may be embodied as a multi-core processor, a single core processor, or a combination of one or more multi-core processors and one or more single core processors. For example, the processor may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor may be configured to execute hard-coded functionality. In an embodiment, the processor is embodied as an executor of software instructions, wherein the instructions may specifically configure the processor to perform at least one of the models, sequences, algorithms and/or operations described herein when the instructions are executed.

The memory may be embodied as one or more volatile memory devices, one or more non-volatile memory devices, and/or a combination of one or more volatile memory devices and non-volatile memory devices. For example, the memory may be embodied as semiconductor memories (such as mask ROM, PROM (programmable ROM), EPROM (erasable PROM), flash ROM, RAM (random access memory), etc.).

The at least one memory and the computer program code may be configured to, with the at least one processor, cause the system 700 to at least perform as follows: receive data from the first wearable sensor apparatus, the data comprising measured IMU data related to a user gesture, the user gesture comprising at least one motion feature, receive data from the second sensor apparatus, the data comprising IMU data, for example UWB data, barometer data, (in several cases comparative data), compute at least one motion feature based at least in part on the received data from the first wearable sensor apparatus, the computing based at least in part on the received data from the first wearable sensor apparatus and the received data from the second sensor apparatus, provide the computed at least one motion feature to a gesture classifier (380), determine, using the gesture classifier (380), the user gesture based at least in part on the computed at least one motion feature, output the determined user gesture.

The embodiments disclosed provide a technical solution to a technical problem. One technical problem being solved is how to accurately recognize or interpret gestures being performed by the user.

The embodiments herein overcome these limitations by using computational methods and apparatuses in order to compute motion features which assist in classifying the gestures. Further, using a second device as a reference is beneficial in recognizing gestures which would otherwise be hard to recognize. Other technical improvements may also flow from these embodiments, and other technical problems may be solved.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

The present disclosure can also be utilized via the following clauses.

Clause X1. A second sensor apparatus comprising a sensor element comprising at least one of: a IMU or a UWB antenna, configured to measure a user, and the apparatus further comprising a controller comprising a processing core, at least one memory including computer program code; the at least one memory and the computer program code being configured to, with the at least one processing core, cause the controller at least to: automatically calibrate the second sensor apparatus based on at least one of the following: a magnetometer reading from the IMU or a received reference data.

Clause 1. A system comprising: a first wearable sensor apparatus comprising a IMU configured to measure a user, a wearable component, for example a mounting component, attached to the IMU; the system further comprising a second sensor apparatus comprising a sensor element comprising at least one of: a IMU or a UWB antenna, configured to measure a user, and the system further comprising a controller comprising a processing core, at least one memory including computer program code; the first wearable sensor apparatus and the second sensor apparatus being configured to communicate with the controller, the at least one memory and the computer program code being configured to, with the at least one processing core, cause the controller at least to: receive data from the first wearable sensor apparatus, the data comprising measured IMU data related to a user gesture, receive data from the second sensor apparatus, the data comprising at least one of: IMU data, UWB data, or barometer data, compute at least one motion feature, the computing based at least in part on the received data from the first wearable sensor apparatus and the received data from the second sensor apparatus, provide the computed at least one motion feature to a gesture classifier, determine, using the gesture classifier, the user gesture based at least in part on the computed at least one motion feature, output the determined user gesture.

Clause 2. The system of clause 1, wherein the determined user gesture is output as a confidence value.

Clause 3. The system of any one of the preceding clauses, wherein the controller comprises a gesture interpreter, and wherein the determined user gesture is provided to the gesture interpreter as an input.

Clause 4. The system of any one of the preceding clauses, wherein the gesture interpreter is configured to adjust the determination based on at least one of an affordance profile and/or a user intent estimate.

Clause 5. The system of any one of the preceding clauses wherein the output of the gesture classifier is a ranked list of probabilities corresponding to candidate gestures, based at least in part on the received data.

Clause 6. The system of any one of the preceding clauses wherein the output of the gesture classifier must satisfy a threshold within the gesture interpreter to qualify as an output gesture of the controller.

Clause 7. The system of any one of the preceding clauses wherein the threshold is adjusted based on at least one of an affordance profile and/or a user intent estimate.

Clause 8. The system of any one of the preceding clauses, wherein the computed motion features comprise axis-specific motion features, for example acceleration and velocity along the palmar/dorsal, ulnar/radial, and up/down axes.

Clause 9. The system of any one of the preceding clauses, wherein the computed motion features comprise axis of rotation estimation, for example analyzing rotational velocity based on gyroscope data to determine angular motion, and correlating rotational velocity with acceleration vectors.

Clause 10. The system of any one of the preceding clauses, wherein the computed motion features comprise temporal and/or frequency domain features, for example time-domain metrics comprising at least one of peak acceleration, velocity magnitude, and duration of motion events; and/or frequency-domain analysis comprising identification of periodic and/or oscillatory motion patterns, wherein the patterns may be associated with specific predetermined gestures.

Clause 11. The system of any one of the preceding clauses, wherein the controller is further configured to use a recurrent model to capture gesture history and improve statefulness detection.

Clause 12. The system of any one of the preceding clauses, wherein the controller is further configured to perform onboard processing comprising the preprocessing, the gesture classification and the gesture interpretation.

Clause 13. The system of any one of the preceding clauses, wherein the first wearable sensor apparatus comprises the controller.

Clause 14. The system of any one of the preceding clauses, wherein the second sensor apparatus comprises the controller.

Clause 15. The system of any one of the preceding clauses, wherein a single housing comprises the controller and at least one of the first wearable sensor apparatus or the second sensor apparatus.

Clause 16. The system of any one of the preceding clauses, wherein the second sensor apparatus is wearable.

Clause 17. The system of any one of the preceding clauses, wherein the second sensor apparatus is a smart phone.

Clause 18. The system of any one of the preceding clauses, wherein a smart phone comprises the controller.

Clause 19. The system of any one of the preceding clauses, wherein the gesture classifier comprises a neural network classifier.

Clause 20. The system of any one of the preceding clauses, wherein at least one of the controller, the first wearable sensor apparatus, or the second sensor apparatus comprises a strap configured to be wearable by the user.

Clause 21. The system of any one of the preceding clauses, wherein at least one of the controller, the first wearable sensor apparatus, or the second sensor apparatus comprises a ring configured to be wearable by the user.

Clause 22. The system of any one of the preceding clauses, wherein at least one of the controller, the first wearable sensor apparatus, or the second sensor apparatus comprises a glove configured to be wearable by the user.

Clause 23. The system of any one of the preceding clauses, wherein at least one of the first wearable sensor apparatus or the second sensor apparatus is configured to be connected to the controller using a wireless connection.

Clause 24. The system of any one of the preceding clauses, wherein at least one of the first wearable sensor apparatus or the second sensor apparatus is configured to be connected to the controller using a wired connection.

Clause 25. The system of any one of the preceding clauses, wherein at least one of the first wearable sensor apparatus or the second sensor apparatus is configured to be connected to the controller using a skin surface electrical connection.

Clause 26. The system of any one of the preceding clauses, comprising at least two first wearable sensor apparatuses.

Clause 27. The system of any one of the preceding clauses, comprising at least two second sensor apparatuses.

Clause 28. The system of any one of the preceding clauses, wherein at least one of the first wearable sensor apparatus or the second sensor apparatus is configured to be connected to each other using a wireless connection.

Clause 29. The system of any one of the preceding clauses, wherein at least one of the first wearable sensor apparatus or the second sensor apparatus is configured to be connected to each other using a wired connection.

Clause 30. The system of any one of the preceding clauses, wherein the system comprises at least: the first wearable sensor apparatus arranged on the user's wrist, the second sensor apparatus arranged on the user's other wrist, and the controller arranged on the user's torso.

Clause 31. The system of any one of the preceding clauses, wherein the user gesture comprises at least one motion feature.

Clause 32. The system of any preceding clauses, wherein the data from the second sensor apparatus is used to calculate comparative data, said comparative data comprising at least one comparison between the data received from the first sensor apparatus and the second sensor apparatus.

Clause 33. A system comprising: a first wearable sensor apparatus comprising a IMU configured to measure a user, a wearable component, for example a mounting component, attached to the IMU; and the system further comprising a controller comprising a processing core, at least one memory including computer program code; the first wearable sensor apparatus being configured to communicate with the controller, the at least one memory and the computer program code being configured to, with the at least one processing core, cause the controller at least to: receive data from the first wearable sensor apparatus, the data comprising measured IMU data related to a user gesture, compute at least one motion feature, the computing based at least in part on the received data from the first wearable sensor apparatus, provide the computed at least one motion feature to a gesture classifier, determine, using the gesture classifier, the user gesture based at least in part on the computed at least one motion feature, output the determined user gesture.

Clause 34. The system of clause 33, wherein the computed motion features comprise axis-specific motion features, for example acceleration and velocity along the palmar/dorsal, ulnar/radial, and up/down axes.

Clause 35. The system of clause 33 or clause 34, wherein the computed motion features comprise axis of rotation estimation, for example analyzing rotational velocity based on gyroscope data to determine angular motion, and correlating rotational velocity with acceleration vectors.

Clause 36. The system of any one of clause 33 or clause 34 or clause 35, wherein the computed motion features comprise temporal and/or frequency domain features, for example time-domain metrics comprising at least one of peak acceleration, velocity magnitude, and duration of motion events; and/or frequency-domain analysis comprising identification of periodic and/or oscillatory motion patterns, wherein the patterns may be associated with specific predetermined gestures.

Clause 37. The system of any one of the clauses 33-36, wherein the first wearable sensor apparatus is configured to be connected to the controller using a wired connection.

Clause 38. The system of any one of the clauses 33-37, wherein the first wearable sensor apparatus is configured to be connected to the controller using a skin surface electrical connection.

Clause 39. A method for gesture identification, the method comprising: receiving data from the first wearable sensor apparatus, the data comprising measured IMU data related to a user gesture, the user gesture comprising at least one motion feature, receiving data from a second sensor apparatus, the data comprising at least one of IMU data, UWB data, barometer data, the first wearable sensor apparatus and the second sensor apparatus being configured to communicate with a controller comprising a processing core, at least one memory including computer program code, computing, by the controller, at least one motion feature, the computing based at least in part on the received data from the first wearable sensor apparatus and the received data from the second sensor apparatus, providing the computed at least one motion feature to a gesture classifier, determining, using the gesture classifier, the user gesture based at least in part on the computed at least one motion feature, and outputting the determined user gesture.

Clause 40. The method of clause 39, wherein the determined user gesture is output as a confidence value.

Clause 41. The method of any one of clauses 39-40, wherein the controller comprises a gesture interpreter, and wherein the determined user gesture is provided to the gesture interpreter as an input.

Clause 42. The method of any one of clauses 39-41, wherein the gesture interpreter is configured to adjust the determination based on at least one of an affordance profile and/or a user intent estimate.

Clause 43. The method of any one of clauses 39-42, wherein the output of the gesture classifier is a ranked list of probabilities corresponding to candidate gestures, based at least in part on the received data.

Clause 44. The method of any one of clauses 39-43, wherein the output of the gesture classifier must satisfy a threshold within the gesture interpreter to qualify as an output gesture of the controller.

Clause 45. The method of any one of clauses 39-44, wherein the threshold is adjusted based on at least one of an affordance profile and/or a user intent estimate.

Clause 46. The method of any one of clauses 39-45, wherein the computed motion features comprise axis-specific motion features, for example acceleration and velocity along the palmar/dorsal, ulnar/radial, and up/down axes.

Clause 47. The method of any one of clauses 39-46, wherein the computed motion features comprise axis of rotation estimation, for example analyzing rotational velocity based on gyroscope data to determine angular motion, and correlating rotational velocity with acceleration vectors.

Clause 48. The method of any one of clauses 39-47, wherein the computed motion features comprise temporal and/or frequency domain features, for example time-domain metrics comprising at least one of peak acceleration, velocity magnitude, and duration of motion events; and/or frequency-domain analysis comprising identification of periodic and/or oscillatory motion patterns, wherein the patterns may be associated with specific predetermined gestures.

Clause 49. The method of any one of clauses 39-48, wherein the controller is further configured to use a recurrent model to capture gesture history and improve statefulness detection.

Clause 50. The method of any one of clauses 39-49, wherein the controller is further configured to perform onboard processing comprising the preprocessing, the gesture classification and the gesture interpretation.

Clause 51. The method of any one of clauses 39-50, wherein the first wearable sensor apparatus comprises the controller.

Clause 52. The method of any one of clauses 39-51, wherein the second sensor apparatus comprises the controller.

Clause 53. The method of any one of clauses 39-52, wherein a single housing comprises the controller and at least one of the first wearable sensor apparatus or the second sensor apparatus.

Clause 54. The method of any one of clauses 39-53, wherein the second sensor apparatus is wearable.

Clause 55. The method of any one of clauses 39-54, wherein the second sensor apparatus is a smart phone.

Clause 56. The method of any one of clauses 39-55, wherein a smart phone comprises the controller.

Clause 57. The method of any one of clauses 39-56, wherein the gesture classifier comprises a neural network classifier.

Clause 58. The method of any one of clauses 39-57, wherein at least one of the controller, the first wearable sensor apparatus, or the second sensor apparatus comprises a strap configured to be wearable by the user.

Clause 59. The method of any one of claims 39-58, wherein at least one of the controller, the first wearable sensor apparatus, or the second sensor apparatus comprises a ring configured to be wearable by the user.

Clause 60. The method of any one of clauses 39-59, wherein at least one of the controller, the first wearable sensor apparatus, or the second sensor apparatus comprises a glove configured to be wearable by the user.

Clause 61. The method of any one of clauses 39-60, wherein at least one of the first wearable sensor apparatus or the second sensor apparatus is configured to be connected to the controller using a wireless connection.

Clause 62. The method of any one of clauses 39-61, wherein at least one of the first wearable sensor apparatus or the second sensor apparatus is configured to be connected to the controller using a wired connection.

Clause 63. The method of any one of clauses 39-62, wherein at least one of the first wearable sensor apparatus or the second sensor apparatus is configured to be connected to the controller using a skin surface electrical connection.

Clause 64. The method of any one of clauses 39-63, comprising at least two first wearable sensor apparatuses.

Clause 65. The method of any one of clauses 39-64, comprising at least two second sensor apparatuses.

Clause 66. The method of any one of clauses 39-65, wherein at least one of the first wearable sensor apparatus or the second sensor apparatus is configured to be connected to each other using a wireless connection.

Clause 67. The method of any one of clauses 39-66, wherein at least one of the first wearable sensor apparatus or the second sensor apparatus is configured to be connected to each other using a wired connection.

Clause 68. The method of any one of clauses 39-67, wherein the system comprises at least: the first wearable sensor apparatus arranged on the user's wrist, the second sensor apparatus arranged on the user's other wrist, and the controller arranged on the user's torso.

Clause 69. The method of any one of clauses 39-68, wherein the user gesture comprises at least one motion feature.

Clause 70. The method of any one of clauses 39-69, wherein the data from the second sensor apparatus is used to calculate comparative data, said comparative data comprising at least one comparison between the data received from the first sensor apparatus and the second sensor apparatus.

Clause 71. The method of any one of clauses 39-70, wherein the first wearable sensor apparatus comprises a IMU configured to measure a user, a wearable component, for example a mounting component, attached to the IMU; and wherein the second sensor apparatus comprises a sensor element comprising at least one of: a IMU or a UWB antenna, said sensor element configured to measure a user.

Clause 72. The method of any one of clauses 39-71, wherein computing the motion feature comprises integration of acceleration to estimate velocity, with filtering to eliminate unbounded drift.

Clause 73. The method of any one of clauses 39-72, wherein computing the motion feature comprises temporal and frequency-domain analysis of IMU data to extract motion characteristics.

Clause 74. The method of any one of clauses 39-73, wherein computing the motion feature comprises estimating the effective axis of rotation by correlating rotational velocity with acceleration vectors, optionally accounting for hand and forearm dynamics.

Clause 75. The system of any one of clauses 1-38, wherein computing the motion feature comprises estimating the effective axis of rotation by correlating rotational velocity with acceleration vectors, optionally accounting for hand and forearm dynamics.

Clause 76. The system of any one of clauses 1-38 or 75, wherein computing the motion feature comprises integration of acceleration to estimate velocity, with filtering to eliminate unbounded drift.

Clause 77. The system of any one of clauses 1-38 or 75 or 76, wherein computing the motion feature comprises temporal and frequency-domain analysis of IMU data to extract motion characteristics.

Clause 78. A method for gesture identification, the method comprising: receiving data from the first wearable sensor apparatus, the data comprising measured IMU data related to a user gesture, the user gesture comprising at least one motion feature, compute, by the controller, at least one motion feature, the computing based at least in part on the received data from the first wearable sensor apparatus, provide the computed at least one motion feature to a gesture classifier, determine, using the gesture classifier (380), the user gesture based at least in part on the computed at least one motion feature, and output the determined user gesture.

Clause 79. The method of clause 78, wherein the computed motion features comprise axis-specific motion features, for example acceleration and velocity along the palmar/dorsal, ulnar/radial, and up/down axes.

Clause 80. The method of clause 78 or clause 79, wherein the computed motion features comprise axis of rotation estimation, for example analyzing rotational velocity based on gyroscope data to determine angular motion, and correlating rotational velocity with acceleration vectors.

Clause 81. The method of any one of clause 78 or clause 79 or clause 80, wherein the computed motion features comprise temporal and/or frequency domain features, for example time-domain metrics comprising at least one of peak acceleration, velocity magnitude, and duration of motion events; and/or frequency-domain analysis comprising identification of periodic and/or oscillatory motion patterns, wherein the patterns may be associated with specific predetermined gestures.

Clause 82. The method of any one of the clauses 78-81, wherein the first wearable sensor apparatus is configured to be connected to the controller using a wired connection.

Clause 83. The method of any one of the clauses 78-82, wherein the first wearable sensor apparatus is configured to be connected to the controller using a skin surface electrical connection.

Clause 84. The method of any one of clauses 78-83, wherein computing the motion feature comprises integration of acceleration to estimate velocity, with filtering to eliminate unbounded drift.

Clause 85. The method of any one of clauses 78-84, wherein computing the motion feature comprises temporal and frequency-domain analysis of IMU data to extract motion characteristics.

Clause 86. The method of any one of clauses 78-83, wherein computing the motion feature comprises estimating the effective axis of rotation by correlating rotational velocity with acceleration vectors, optionally accounting for hand and forearm dynamics.

Clause 87. The system or method of any one of the preceding clauses, wherein the neural network model is a convolutional neural network comprising multiple convolutional layers for feature extraction.

Clause 88. The system or method of any one of the preceding clauses, wherein the trained neural network model is trained with supervised training, for example using (labeled) data and/or augmented data.

Clause 89. The system or method of any one of the preceding clauses, wherein the trained neural network model is trained with a snapshot, the snapshot comprising a foundational model.

Clause 90. The system or method of any one of the preceding clauses, further comprising preprocessing the input data, for example the IMU data, by normalizing, scaling, or filtering, for example to enhance model accuracy.

Clause 91. The system or method of any one of the preceding clauses, further comprising post-processing the output of the neural network model by applying thresholding to classify the input data into distinct categories.

Clause 92. The system or method of any one of the preceding clauses, wherein the neural network model is trained using transfer learning with a pre-trained model as a base.

Clause 93. The system or method of any one of the preceding clauses, wherein the neural network model is configured to achieve an accuracy of at least 95% on a validation dataset.

Clause 94. The system or method of any one of the preceding clauses wherein the neural network model is trained with a learning rate of 0.0001 to 0.01, or 1e-5 to 1e-4.

Clause 95. The system or method of any one of the preceding clauses, wherein the neural network model is trained with a batch size of 2 to 32, or 64 to 256.

Clause 96. The system or method of any one of the preceding clauses, wherein the neural network model is executed on a distributed computing system to accelerate processing speed.

Clause 97. A method for training a machine learning model configured to classify a measured movement based at least in part on motion features computed based on data related to the measured movement, wherein the training comprises supervised training, for example using (labeled) data and/or augmented data, wherein the labeled data comprises movement information based on IMU data measured from at least one user performing a gesture.

Clause 98. The method of clause 97, wherein the labeled data further comprises reference information measured by a different device than the data related to the measured movement.

Clause 99. A trained machine learning model configured to classify a measured gesture based at least in part on computed motion features relating to the gesture, wherein the training comprises supervised training, for example using (labeled) data and/or augmented data, wherein the labeled data comprises movement information based on IMU data measured from at least one user performing a gesture.

Clause 100. The model of clause 99, wherein the labeled data further comprises reference information measured by a different device than the data related to the measured movement.

Clause 101. A non-transitory computer readable medium having stored thereon a set of computer readable instructions that, when executed by at least one processor, cause an apparatus to at least: receive data from the first wearable sensor apparatus, the data comprising measured IMU data related to a user gesture, the user gesture comprising at least one motion feature, receive data from a second sensor apparatus, the data comprising at least one of IMU data, UWB data, barometer data, the first wearable sensor apparatus and the second sensor apparatus being configured to communicate with a controller comprising a processing core, at least one memory including computer program code, compute at least one motion feature, the computing based at least in part on the received data from the first wearable sensor apparatus and the received data from the second sensor apparatus, provide the computed at least one motion feature to a gesture classifier, determine, using the gesture classifier, the user gesture based at least in part on the computed at least one motion feature, and output the determined user gesture.

Clause 102. The non-transitory computer readable medium of clause 101, further comprising instructions to perform any one of the methods of clauses 1-100.

Clause 103. A computer program configured to cause a method in accordance with at least one of clauses 39-73, 78-83, 87-96 or 97-98 to be performed.

### INDUSTRIAL APPLICABILITY

At least some embodiments of the present invention find industrial application in recognizing and transmitting gestures performed by a user, for example for control or communication purposes.

1. A system comprising:
a first wearable sensor apparatus comprising:
a IMU configured to measure a user, and
a wearable component, for example a mounting component, attached to the IMU;
the system further comprising a second sensor apparatus comprising:
a sensor element comprising at least one of: a IMU or a UWB antenna, configured to measure a user,
and the system further comprising a controller comprising a processing core, at least one memory including computer program code;
the first wearable sensor apparatus and the second sensor apparatus being configured to communicate with the controller, and
the at least one memory and the computer program code being configured to, with the at least one processing core, cause the controller at least to:
receive data from the first wearable sensor apparatus, the data comprising measured IMU data related to a user gesture,
receive data from the second sensor apparatus, the data comprising at least one of: IMU data, UWB data, or barometer data,
compute at least one motion feature, the computing based at least in part on the received data from the first wearable sensor apparatus and the received data from the second sensor apparatus,
provide the computed at least one motion feature to a gesture classifier,
determine, using the gesture classifier, the user gesture based at least in part on the computed at least one motion feature, and
output the determined user gesture.

2. The system of claim 1, wherein the determined user gesture is output as a confidence value.

3. The system of claim 1, wherein the controller comprises a gesture interpreter, and wherein the determined user gesture is provided to the gesture interpreter as an input.

4. The system of claim 1, wherein the gesture interpreter is configured to adjust the determination based on at least one of an affordance profile and/or a user intent estimate.

5. The system of claim 1, wherein the output of the gesture classifier is a ranked list of probabilities corresponding to candidate gestures, based at least in part on the received data.

6. The system of claim 1, wherein the output of the gesture classifier must satisfy a threshold within the gesture interpreter to qualify as an output gesture of the controller.

7. The system of claim 1, wherein the threshold is adjusted based on at least one of an affordance profile and/or a user intent estimate.

8. The system of claim 1, wherein the computed motion features comprise axis-specific motion features, for example acceleration and velocity along the palmar/dorsal, ulnar/radial, and up/down axes.

9. The system of claim 1, wherein the computed motion features comprise axis of rotation estimation, for example analyzing rotational velocity based on gyroscope data to determine angular motion, and correlating rotational velocity with acceleration vectors.

10. The system of claim 1, wherein the computed motion features comprise temporal and/or frequency domain features, for example time-domain metrics comprising at least one of peak acceleration, velocity magnitude, and duration of motion events; and/or frequency-domain analysis comprising identification of periodic and/or oscillatory motion patterns, wherein the patterns may be associated with specific predetermined gestures.

11. The system of claim 1, wherein the controller is further configured to use a recurrent model to capture gesture history and improve statefulness detection.

12. The system of claim 1, wherein the controller is further configured to perform onboard processing comprising the preprocessing, the gesture classification and the gesture interpretation.

13. The system of claim 1, wherein the first wearable sensor apparatus comprises the controller.

14. The system of claim 1, wherein the second sensor apparatus comprises the controller.

15. A method for gesture identification, the method comprising:
receiving data from a first wearable sensor apparatus, the data comprising measured IMU data related to a user gesture, the user gesture comprising at least one motion feature,
receiving data from a second sensor apparatus, the data comprising at least one of IMU data, UWB data, barometer data, the first wearable sensor apparatus and the second sensor apparatus being configured to communicate with a controller comprising a processing core, at least one memory including computer program code,
computing, by the controller, at least one motion feature, the computing based at least in part on the received data from the first wearable sensor apparatus and the received data from the second sensor apparatus,
providing the computed at least one motion feature to a gesture classifier,
determining, using the gesture classifier, the user gesture based at least in part on the computed at least one motion feature, and
outputting the determined user gesture.

16. The method of claim 15, wherein the controller comprises a gesture interpreter, and wherein the determined user gesture is provided to the gesture interpreter as an input.

17. The method of claim 15, wherein the computed motion features comprise axis-specific motion features, for example acceleration and velocity along the palmar/dorsal, ulnar/radial, and up/down axes.

18. The method of claim 15, wherein the computed motion features comprise axis of rotation estimation, for example analyzing rotational velocity based on gyroscope data to determine angular motion, and correlating rotational velocity with acceleration vectors.

19. The method of claim 15, wherein the computed motion features comprise temporal and/or frequency domain features, for example time-domain metrics comprising at least one of peak acceleration, velocity magnitude, and duration of motion events; and/or frequency-domain analysis comprising identification of periodic and/or oscillatory motion patterns, wherein the patterns may be associated with specific predetermined gestures.

20. A non-transitory computer readable medium having stored thereon a set of computer readable instructions that, when executed by at least one processor, cause an apparatus to at least:
receive data from a first wearable sensor apparatus, the data comprising measured IMU data related to a user gesture, the user gesture comprising at least one motion feature,
receive data from a second sensor apparatus, the data comprising at least one of IMU data, UWB data, barometer data, the first wearable sensor apparatus and the second sensor apparatus being configured to communicate with a controller comprising a processing core, at least one memory including computer program code,
compute at least one motion feature, the computing based at least in part on the received data from the first wearable sensor apparatus and the received data from the second sensor apparatus,
provide the computed at least one motion feature to a gesture classifier,
determine, using the gesture classifier, the user gesture based at least in part on the computed at least one motion feature, and
output the determined user gesture.
